(19) United States
(12) Patent Application Publication
(10) Pub. No.: US 2004/0046730 A1
(43) Pub. Date: Mar. 11, 2004

(54) LCD (liquid crystal display) with a back light source characterized by light source local penetration

(76) Inventors: Kazuhiro Miyashita, Kaohsiung City (TW); Wen-Hsiang Chang, Kaohsiung City (TW); Yen-Chuan Chu, Kaohsiung City (TW); Yu-Bing Liu, Kaohsiung Hsien (TW)

Correspondence Address: Leong C. Lei, PMB #1008, 1867 Ygnacio Valley Road, WALNUT CREEK, CA, 94598-3214, US

(21) Appl. No.: 10/224,458

(22) Filed: Aug. 21, 2002

(51) Int. Cl. G09G 3/36

(52) U.S. Cl. 345/102

(57) ABSTRACT

The invention is related to an LCD (Liquid Crystal Display) with a back light source characterized by light source local penetration. There is a reflective layer on the bottom of the LCD. The reflective layer contains some light channels. A micro lens-film is placed between the LCD and the back light source. The micro lens-film contains some light collection sections in such a way that individual light collection sections are opposite individual light channels. The invention has two merits. Firstly, the reflective layer reflects incident daylight greatly so as to help illuminate the LCD. Secondly, the light emitted by the back light source is condensed by the light collection sections before passing through the light channels, so that it helps illuminate the LCD. Not only is the LCD illuminated better, but the images it shows also have better contrast under daylight. Hence, the images displayed on the LCD screens are greatly improved.

### BACKGROUND OF THE INVENTION

The advent of the information era sees a ceaseless surge of human beings' demand for the latest information. In the near future, human beings will enjoy acquiring, or even compete for, the information that is accessible to them in a speedy, voluminous manner. With plenty of advanced equipment, a great amount of information is efficiently transferred among the people anytime. An LCD is indispensable to information transmission nowadays.

Every notebook computer or cellular phone is equipped with a LCD for displaying the information sent or received. Frequently, LCDs may be used outdoors but be blamed for their poor performance. This does not occur without any reason. In general, the light source available to a LCD is the back light panel module on the bottom of the LCD. However, the brilliance of the light sent out by the back light panel module is much lower than that of daylight. As a result, whenever a LCD is used outdoors in the daytime, the screen display has worse contrast and thus it is not shown clearly. Increasing the illumination of the back light panel module invariably, will not only waste electricity and shorten the life of the other working components, but also make little improvement in the brilliance.

To solve the problem, manufacturers nowadays resort to two known methods. Firstly, the back light panel module of a LCD is replaced by a front light source found in the anterior part of the LCD. As shown in FIG. 1, the remedial structure is composed of a reflection-style LCD 1 and its front light source 2. The front light source 2 has a light-guide plate 21. It also has a cooled-cathode fluorescent tube 22 beside the light-guide plate 21. The illumination surface of the light-guide plate 21 is designed in such a way that it has a continuous reflective oblique surface A-B. To reduce irregular reflection and diffused reflection, the side of the light-guide plate 21 opposite the LCD 1 is plated, or covered, with an AR-coating 23. While a small part of the rays of light emitted by the cooled-cathode fluorescent tube 22 enter the LCD 1 directly and then reflect off the LCD 1, most of them reflect off the reflective oblique surface A-B, enter the LCD 1, and then reflect off the LCD

1. Nevertheless, the remedial structure has not yet undergone mass production, because of the following shortcomings.

1. The light-guide plate 21 of the front light source 2 is positioned above the LCD 1. The manufacturing process has to be highly sophisticated, so that users are unable to see the rough surface of the light-guide plate 21 with the naked eye and the images displayed on the screens are of high quality. However, such a manufacturing process is rather expensive and difficult.

2. The reflective oblique surface A-B found on the light-guide plate 21 of the front light source 2 reflects light in a general way. Much of the light is refracted when it passes through the reflective oblique surface A-B. Hence, the refracted light 1 is useless and overwhelming, whereas the amount of the useful light 11 available to the LCD 1 is limited.

3. The light-guide plate 21 is plated, or covered, with an AR-coating 23 so as to reduce irregular reflection and diff-used reflection. For this reason, the manufacturing process is rather expensive and difficult.

FIG. 2 depicts another known method. Aback light source 4 is installed behind a LCD 3. The bottom of the LCD is covered with a lens-film 31 characterized by part reflection and part transmission. The back light source 4 has a light-guide plate 41. It also has a cooled-cathode fluorescent tube 42 beside the light-guide plate 41. Manufacturers adopt a kind of semi-reflective, semi-transmissive lens-film 31 which reflects 80% of incident daylight and allows 20% of the remainder to pass through it and enter the LCD 3. In other words, 80% of incident daylight 12 reflects off the lens-film 31, whereas merely 20% of the self-made light 13 sent out by the light-guide plate 41 passes through the lens-film 31 and enters the LCD 3. For example, suppose the LCD 3 is exposed to 10000 cd/cm2 of daylight 12, the lens-film 31 will reflect 8000 cd/cm2 of daylight 12 which will then be available to the LCD 3. By the same token, suppose 2000 cd/cm2 of the self-made light 13 is sent out by the light-guide plate 41, only 400 cd/cm2 of it will pass through the lens-film 31 and then be available to the LCD 3. Hence, in this example, a mere total of 8400 cd/cm2 of light is available to the LCD 3, though the LCD 3 is exposed to 10000 cd/cm2 of daylight 12. The difference between the two figures accounts for the poor contrast of any image shown on a LCD screen under daylight. More badly, the stronger daylight 12 is, the worse is the contrast.

### BRIEF DESCRIPTION OF THE DRAWINGS

FIG. 1 illustrates how a known LCD works;

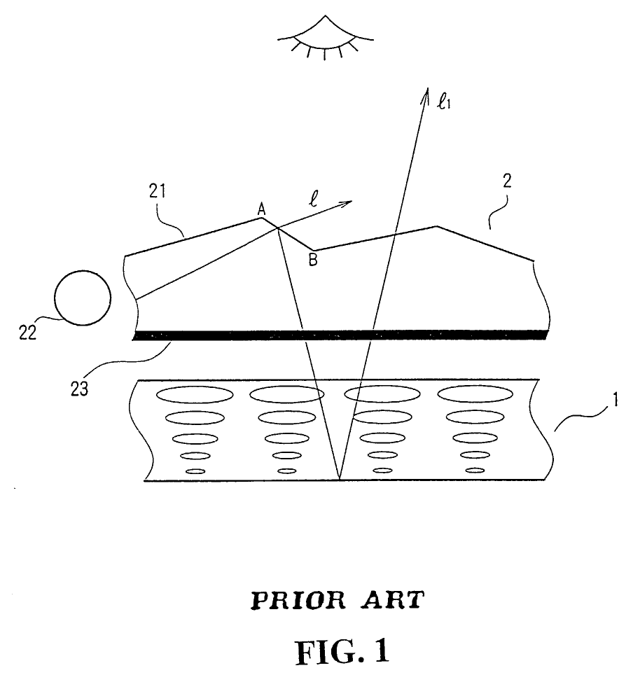

FIG. 3 illustrates how another known LCD works;

FIG. 3 depicts the structure of a preferred embodiment of the creation; and

FIG. 4 illustrates how the preferred embodiment works.

### SUMMARY OF THE INVENTION

The primary object of the creation is to provide a LCD with a back light source characterized by light source local penetration. There is a reflective layer on the bottom of the LCD. The reflective layer contains some light channels. A micro lens-film is placed between the LCD and the back light source. The micro lens-film contains some light collection sections in such a way that individual light collection sections are opposite individual light channels of the reflective layer. The creation has two merits. Firstly, when the front of the LCD is exposed to strong daylight, the reflective layer reflects incident daylight to an extent so great that incident daylight is available to the LCD. Secondly, the light emitted by the light-guide plate is condensed by the light collection sections of the micro lens-film before passing through the light channels, and eventually be available to the LCD. As a result, not only is the LCD illuminated better, but the images it shows also have better contrast under daylight. Hence, the images displayed on the LCD screens are greatly improved.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

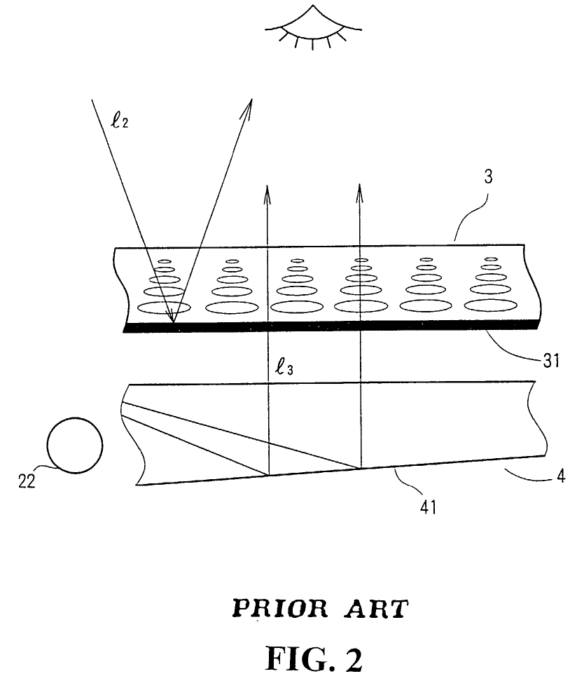

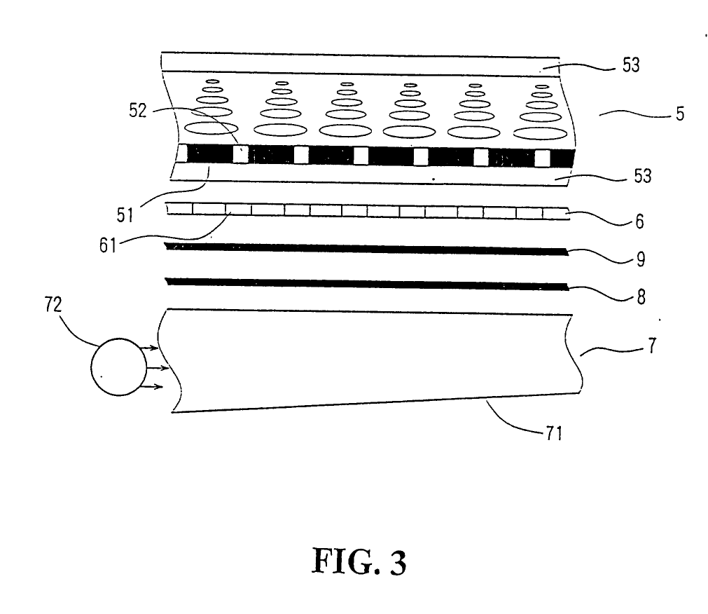

Please refer to FIG. 3 first. As regards the creation, there is a high-quality reflective layer 51 on the bottom of the LCD 5. The reflective layer 51 contains a plurality of light channels 52. The LCD 5 and the reflective layer 51 are joined together by a glass shade 53 and become one single structure. There are various solutions as to the material and formation of the reflective layer 51, though this is beyond the scope of the discussion on the creation and thus this is not to be mentioned again in the following paragraphs. A micro lens-film 6 is also installed on the bottom of the LCD 5. The micro lens-film 6 contains some light collection sections 61, which act as condensers, in such a way that individual light collection sections 61 are opposite individual light channels 52 of the reflective layer 51. Aback light source 7 is installed behind the micro lens-film 6. The back light source 7 works together with a light-guide plate 71. There is a cooled-cathode fluorescent tube 72 beside the light-guide plate 71. There are a diffusing film 8 and a condenser 9 between the micro lens-film 6 and the back light source 7. They are not discussed below as they do not belong to the following claims.

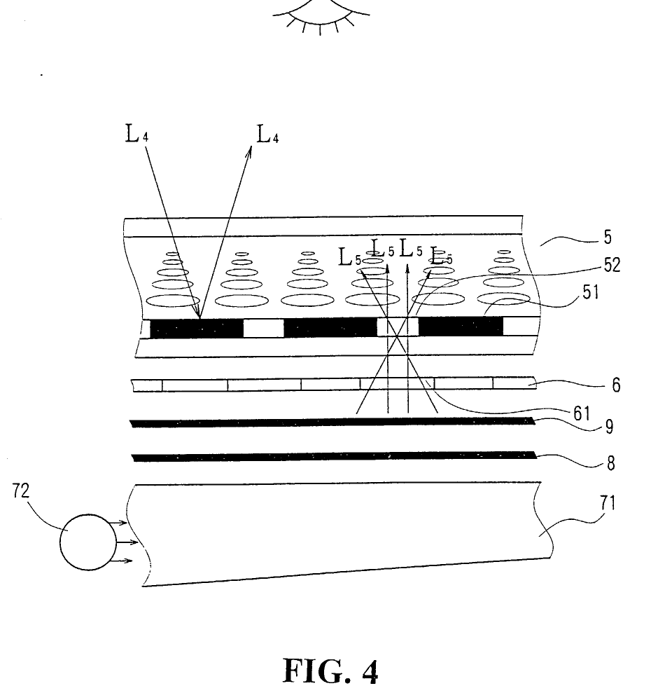

Please refer to FIG. 4, which depicts the most important points of the present invention. Whenever daylight L4 enters the LCD 5, most of it reflects off the reflective layer 51 and returns to LCD 5. While passing through the light collection sections 61 of the micro lens-film 6, the self-made light, which is sent out by the light-guide plate 71, is turned into energy-enriched, self-made light L5. Then, the energy-enriched, self-made light L5 passes through the light channels 52 of the reflective layer 51 before it eventually becomes available to the LCD 5. In other words, the illumination of the LCD 5 is a combination of the incident self-made light L5, which is sent out by the light-guide plate 71, be condensed and passes through the light channels 52 before it becomes available to the LCD 5, and the incident daylight LA. Given the design, the illumination required by the LCD 5 is augmented, and under daylight LA the contrast of LCD screens display is improved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A LCD with a back light source characterized by light source local penetration, comprising an LCD, a reflective layer on the bottom of the LCD, a micro-lens reflective film and a back light source, wherein the reflective layer contains a plurality of light channels found all over the layer itself, the micro lens-film contains some light collection sections in such a way that individual light collection sections are opposite individual light channels, incident daylight reflects off the reflective layer, then it is joined by the self-made light which comes from the light-guide plate and passes through the light collection sections and the light channels, the combination of the reflected daylight and the self-made light augments the illumination required by the LCD and improves the contrast of LCD screens display under daylight L4.

2. The LCD with a back light source characterized by light source local penetration of claim 1, wherein the area of individual light collection sections of the micro lens-film may be slightly greater than the area of individual light channels of the reflective layer, so as to enhance the condensing effect.
